(19) United States
(12) Patent Application Publication
(10) Pub. No.: US 2024/0357639 A1
(43) Pub. Date: Oct. 24, 2024

(54) METHODS AND DEVICES FOR SIDELINK TRANSMISSION ON UNLICENSED BAND

(71) Applicant: Telefonaktiebolaget LM Ericsson (publ), Stockholm (SE)

(72) Inventor: Min Wang, Luleå (SE)

(21) Appl. No.: 18/685,645

(22) PCT Filed: Sep. 8, 2022
(86) PCT No.: PCT/EP2022/075032

§ 371 Date: Feb. 22, 2024

Related U.S. Application Data
(60) Provisional application No. 63/276,316, filed on Nov. 5, 2021.

(30) Foreign Application Priority Data
Sep. 10, 2021 (WO) PCT/EP2021/074923
Mar. 11, 2022 (WO) PCT/EP2022/056320

(51) Int. Cl. H04W 74/04; H04W 74/00

(52) U.S. Cl. CPC H04W 74/04; H04W 74/002

(57) ABSTRACT

A method implemented by a first user equipment (UE) for channel occupancy time scheduling information sharing for SL transmission on unlicensed band according to one or more embodiments of the present disclosure. The first UE is in communication with a first network device and a second UE. The first UE may send a COT scheduling information related to one or more COTs for SL transmissions between the first UE and the second UE which are not initiated by the first network device to the first network device to allocate the first UE with first radio resources according to the COT scheduling information within the COT. The first UE may receive a scheduled resource information from the first network device indicating the first radio resources allocated to the first UE to perform a SL transmission.

### TECHNICAL FIELD

The present disclosure generally relates to communication networks, and more specifically to methods and devices for sidelink (SL) transmission on unlicensed band.

### BACKGROUND

Next generation systems are expected to support a wide range of use cases with varying requirements ranging from fully mobile devices to stationary Internet of Things (IoT) or fixed wireless broadband devices. The traffic pattern associated with many use cases is expected to consist of short or long bursts of data traffic with varying length of waiting period in between (here called inactive state). In New Radio (NR), both license assisted access and standalone unlicensed operation are to be supported in 3rd Generation Partnership Project (3GPP). Hence the procedure of Physical Random Access Channel (PRACH) transmission and/or schedule request (SR) transmission in unlicensed spectrum shall be investigated in 3GPP. In the following, NR-U and channel access procedure for an unlicensed channel based on LBT is introduced.

In order to support sidelink transmission on unlicensed spectrum (SL-U), similar channel access mechanism as in NR-U need to be introduced for SL-U. With channel access mechanism, a SL capable user equipment (UE) may need to perform Listen-before-talk (LBT) operation prior to a SL transmission. However, LBT operation will cause transmission latency for the SL transmission.

### SUMMARY

In view of the above problem, the embodiments herein propose methods, network devices, computer readable mediums and computer program products for channel occupancy time scheduling information sharing for SL transmission on unlicensed band.

According to a first aspect of the present disclosure, there is provided a method implemented by a first user equipment (UE) for channel occupancy time scheduling information sharing for SL transmission on unlicensed band according to one or more embodiments of the present disclosure. The first UE is in communication with a first network device and a second UE. The first UE may send a COT scheduling information related to one or more COTs for SL transmissions between the first UE and the second UE which are not initiated by the first network device to the first network device to allocate the first UE with first radio resources according to the COT scheduling information within the COT. The first UE may receive a scheduled resource information from the first network device indicating the first radio resources allocated to the first UE to perform a SL transmission.

According to a second aspect of the present disclosure, there is provided a method implemented by a first network device for channel occupancy time scheduling information sharing for SL transmission on unlicensed band according to one or more embodiments of the present disclosure. The first network device is connected to a first UE. The first UE is in communication with the first network device and a second UE. The first network device may receive a COT scheduling information related to one or more COTs for SL transmissions between the first UE and the second UE which are not initiated by the first network device from the first UE or a second network device to allocate first radio resources according to the COT scheduling information within the COT. The first network device may send a scheduled resource information to the first UE indicating the first radio resources allocated to the first UE to perform a SL transmission.

According to a third aspect of the disclosure there is provided a communication device in a communication network. The communication device may comprise a processor and a memory communicatively coupled to the processor. The memory may be adapted to store instructions which, when executed by the processor, cause the communication device to perform steps of the method according to the above first aspect, and second aspect.

According to a fourth aspect of the present disclosure, there is provided a non-transitory machine-readable medium having a computer program stored thereon. The computer program, when executed by a set of one or more processors of a communication device, causes the communication device to perform steps of the method according to the above first aspect, and second aspect.

### BRIEF DESCRIPTION OF THE DRAWINGS

The present disclosure may be best understood by way of example with reference to the following description and accompanying drawings that are used to illustrate embodiments of the present disclosure.

FIG. 1 is a schematic diagram showing an example of COT sharing initiated by gNB;

FIG. 2 is a schematic diagram showing an example of COT sharing initiated by UE;

FIG. 3 shows an example of the Frame based equipment (FBE) based channel occupancy operation.

FIG. 4 is a schematic block diagram showing a communication system, in which the embodiments herein can be implemented;

FIG. 5 illustrates an exemplary flow diagram for a method implemented by a first UE for channel occupancy time scheduling information sharing for SL transmission on unlicensed band according to one or more embodiments of the present disclosure.

FIG. 6 illustrates an exemplary flow diagram for a method implemented by a first network device for channel occupancy time scheduling information sharing for SL transmission on unlicensed band according to one or more embodiments of the present disclosure.

FIG. 7 is a block diagram illustrating a communication device according to some embodiments of the present disclosure.

FIG. 8 is a block diagram of a communication system includes a telecommunication network 3210, in accordance with an embodiment of the present disclosure.

FIG. 9 illustrates example implementations of the UE, base station and host computer in accordance with an embodiment of the present disclosure.

FIG. 10 is a flowchart illustrating a method implemented in a communication system, in accordance with one embodiment of the present disclosure.

FIG. 11 is a flowchart illustrating a method implemented in a communication system, in accordance with one embodiment of the present disclosure.

FIG. 12 is a flowchart illustrating a method implemented in a communication system, in accordance with one embodiment of the present disclosure.

FIG. 13 is a flowchart illustrating a method implemented in a communication system, in accordance with one embodiment of the present disclosure.

### DETAILED DESCRIPTION

The following detailed description describes methods and apparatuses for binding indication. In the following detailed description, numerous specific details such as logic implementations, types and interrelationships of system components, etc. are set forth in order to provide a more thorough understanding of the present disclosure. It should be appreciated, however, by one skilled in the art that the present disclosure may be practiced without such specific details. In other instances, control structures, circuits and instruction sequences have not been shown in detail in order not to obscure the present disclosure. Those of ordinary skill in the art, with the included descriptions, will be able to implement appropriate functionality without undue experimentation.

As used herein, the terms “first”, “second” and so forth refer to different elements. The singular forms “a”, “an”, and “the” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “according to” is to be read as “at least in part according to”. The term “one embodiment” and “an embodiment” are to be read as “at least one embodiment”. The term “another embodiment” is to be read as “at least one other embodiment”.

Unless otherwise defined, all terms (including technical and scientific terms) used herein have the same meanings as commonly understood. It will be further understood that a term used herein should be interpreted as having a meaning consistent with its meaning in the context of this specification and the relevant art and will not be interpreted in an idealized or overly formal sense unless expressly so defined herein.

Bracketed text and blocks with dashed borders (e.g., large dashes, small dashes, dot-dash, and dots) may be used herein to illustrate optional operations that add additional features to embodiments of the present disclosure. However, such notation should not be taken to mean that these are the only options or optional operations, and/or that blocks with solid borders are not optional in certain embodiments of the present disclosure.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, read only memory (ROM), flash memory devices, phase change memory) and machine-readable transmission media (also called a carrier) (e.g., electrical, optical, radio, acoustical or other form of propagated signals-such as carrier waves, infrared signals). Thus, an electronic device (e.g., a computer) includes hardware and software, such as a set of one or more processors coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on, that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set of or one or more physical network interfaces to establish network connections (to transmit and/or receive code and/or data using propagating signals) with other electronic devices. One or more parts of an embodiment of the present disclosure may be implemented using different combinations of software, firmware, and/or hardware.

In this disclosure, the term “communication device” means the electrical devices used in a communication network. For example, the communication device may be a user equipment or mobile station in any of the communication standard, such as 2G, 3G, 4G, 5G or beyond. For example, the communication device may be a base station, NodeB, eNB, or gNB in any of the communication standard, such as 2G, 3G, 4G, 5G or beyond. As an example, the communication device may be a core network device, such as Authentication Management Function (AMF) or Session Management Function (SMF), etc.

In this disclosure a term node is used which can be a network node or a UE. Examples of network nodes are NodeB, base station (BS), multi-standard radio (MSR) radio node such as MSR BS, eNodeB, gNodeB. MeNB, SeNB, integrated access backhaul (IAB) node, network controller, radio network controller (RNC), base station controller (BSC), relay, donor node controlling relay, base transceiver station (BTS), Central Unit (e.g. in a gNB), Distributed Unit (e.g. in a gNB), Baseband Unit, Centralized Baseband, C-RAN, access point (AP), transmission points, transmission nodes, Remote Radio Unit (RRU), Remote Radio Head (RRH), nodes in distributed antenna system (DAS), core network node (e.g. MSC, MME etc), O&M, Operation Support Systems (OSS), Self-organizing network (SON), positioning node (e.g. E-SMLC),etc.

Another example of a node is user equipment (UE), which is a non-limiting term and refers to any type of wireless device communicating with a network node and/or with another UE in a cellular or mobile communication system. Examples of UE are target device, device to device (D2D) UE, vehicular to vehicular (V2V), machine type UE, MTC UE or UE capable of machine to machine (M2M) communication, PDA, Tablet, mobile terminals, smart phone, laptop embedded equipment (LEE), laptop mounted equipment (LME), USB dongles etc.

In some embodiments, generic terminology, “radio network node” or simply “network node (NW node)”, is used. It can be any kind of network node which may comprise base station, radio base station, base transceiver station, base station controller, network controller, evolved Node B (eNB), Node B, gNodeB (gNB), relay node, access point, radio access point, RRU, RRH, Central Unit (e.g. in a gNB), Distributed Unit (e.g. in a gNB), Baseband Unit, Centralized Baseband, C-RAN, access point (AP) etc.

The term radio access technology, or RAT, may refer to any RAT e.g. UTRA, E-UTRA, narrow band internet of things (NB-IoT), WiFi, Bluetooth, next generation RAT, New Radio (NR), 4G, 5G, etc. Any of the equipment denoted by the terminology node, network node or radio network node may be capable of supporting a single or multiple RATs.

The embodiments are described in the context of NR, i.e., two or more SL UEs are deployed in a same or different NR cell. However, the same principle may be applied to LTE or any other technology that enables the direct connection of two (or more) nearby devices. The embodiments are also applicable to relay scenarios including UE to network relay or UE to UE relay where the remote UE and the relay UE may be based on LTE sidelink or NR sidelink, the Uu connection between the relay UE and the base station may be LTE Uu or NR Uu.

The proposed mechanism is applicable to SL unlicensed operations (i.e., SL transmission on unlicensed band). The term LBT may also interchangeably called as clear channel assessment (CCA), shared spectrum access procedure etc. The carrier on which the LBT is applied may belong to a shared spectrum or an unlicensed band or band with contention based access etc.

In addition, both load based equipment (LBE) based channel access schemes (may also be named as dynamic channel access) and frame base equipment (FBE) based channel access schemes (may also be named as semi static channel access) are covered in the following embodiments.

### NR Based Access to Unlicensed Spectrum

In NR, both license assisted access and standalone unlicensed operation are to be supported in 3GPP. Hence the procedure of PRACH transmission and/or SR transmission in unlicensed spectrum is investigated in 3GPP. In the following, NR-U and channel access procedure for an unlicensed channel based on LBT is introduced.

### NR-U Introduction

In order to tackle with the ever increasing data demanding, NR is supported on both licensed and unlicensed spectrum (i.e., referred to as NR-U). Compared to the Long Term Evolution (LTE) Licensed-Assisted Access (LAA), NR-U supports DC (dual connectivity) and standalone scenarios, where the MAC procedures including RACH and scheduling procedure on unlicensed spectrum are subject to the LBT failures, while there was no such restriction in LTE LAA, since there was licensed spectrum in LAA scenario so the RACH and scheduling related signaling can be transmitted on the licensed spectrum instead of unlicensed spectrum.

For DRS transmission such as Primiary Synchronization Signal (PSS)/Secondary Synchronization Signal (SSS), Physical Broadcast Channel (PBCH), Channel State Information-Reference Signal (CSI-RS), control channel transmission such as Physical Uplink Control Channel (PUCCH)/PDCCH, physical data channel such as Physical Uplink Shared Channel (PUSCH)/Physical Downlink Shared Channel (PDSCH), and uplink sounding reference signal such as Sounding Reference Signal (SRS) transmission, channel sensing should be applied to determine the channel availability before the physical signal is transmitted using the channel.

The Radio Resource Management (RRM) procedures in NR-U would be generally rather similar as in LAA, since NR-U is aiming to reuse LAA/eLAA/feLAA technologies as much as possible to handle the coexistence between NR-U and other legacy RATs. RRM measurements and report comprising special configuration procedure with respect the channel sensing and channel availability.

Hence, channel access/selection for LAA was one of important aspects for co-existence with other RATs such as Wi-Fi. For instance, LAA has aimed to use carriers that are congested with Wi-Fi.

In licensed spectrum, UE measures Reference Signal Received Power (RSRP), and Reference Signal Received Quality (RSRQ) of the downlink radio channel (e.g. Synchronization Signal and PBCH block (SSB), CSI-RS), and provides the measurement reports to its serving eNB/gNB. However, they don't reflect the interference strength on the carrier. Another metric Received Signal Strength Indicator (RSSI) can serve for such purpose. At the eNB/gNB side, it is possible to derive RSSI based on the received RSRP and RSRQ reports, however, this requires that they must be available. Due to the LBT failure, some reports in terms of RSRP or RSRP may be blocked (can be either due to that the reference signal transmission (DRS) is blocked in the downlink or the measurement report is blocked in the uplink). Hence, the measurements in terms of RSSI are very useful. The RSSI measurements together with the time information concerning when and how long time that UEs have made the measurements can assist the gNB/eNB to detect the hidden node. Additionally, the gNB/eNB can measure the load situation of the carrier which is useful for the network to prioritize some channels for load balance and channel access failure avoidance purposes.

LTE LAA has defined to support measurements of averaged RSSI and channel occupancy) for measurement reports. The channel occupancy is defined as percentage of time that RSSI was measured above a configured threshold. For this purpose, a RSSI measurement timing configuration (RMTC) includes a measurement duration (e.g. 1-5 ms) and a period between measurements (e.g. {40, 80, 160, 320, 640} ms).

### COT Sharing in NR-U

For a node (e.g., NR-U gNB/UE, LTE-LAA eNB/UE, or Wi-Fi Access Point (AP)/Station (STA)) to be allowed to transmit in unlicensed spectrum (e.g., 5 GHz band) it typically needs to perform a CCA. This procedure typically includes sensing the medium to be idle for a number of time intervals. Sensing the medium to be idle can be done in different ways, e.g. using energy detection, preamble detection or using virtual carrier sensing. Where the latter implies that the node reads control information from other transmitting nodes informing when a transmission ends. After sensing the medium to be idle, the node is typically allowed to transmit for a certain amount of time, sometimes referred to as transmission opportunity (TXOP). The length of the TXOP depends on regulation and type of CCA that has been performed, but typically ranges from 1 ms to 10 ms. This duration is often referred to as a COT.

In Wi-Fi, feedback of data reception acknowledgements (ACKs) is transmitted without performing clear channel assessment. Preceding feedback transmission, a small time duration (called Short Inter-Frame Space (SIFS)) is introduced between the data transmission and the corresponding feedback which does not include actual sensing of the channel. In IEEE 802.11, the SIFS period (16 μs for 5 GHz Orthogonal Frequency Division Multiplexing (OFDM) Physicals (PHYs)) is defined as:

aSIFSTime=aRxPHYDelay+aMACProcessingDelay+aRxTxTurnaroundTime, in which:
aRxPHYDelay defines the duration needed by the PHY layer to deliver a packet to the MAC layer;
aMACProcessingDelay defines the duration that the MAC layer needs to trigger the PHY layer transmitting a response;
aRxTxTurnaroundTime defines the duration needed to turn the radio from reception into transmit mode.

Therefore, the SIFS duration is used to accommodate for the hardware delay to switch the direction from reception to transmission.

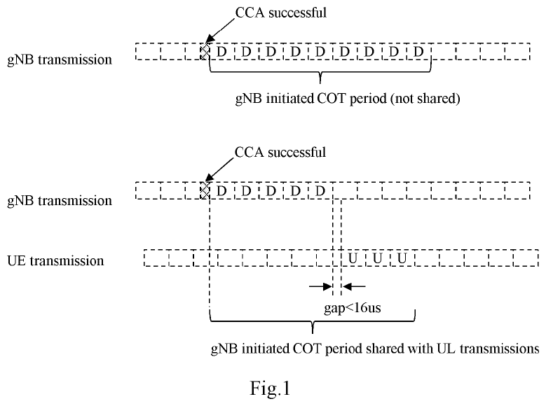

It is anticipated that for NR in unlicensed bands (NR-U), a similar gap to accommodate for the radio turnaround time will be allowed. For example, this will enable the transmission of PUCCH carrying Uplink Control Information (UCI) feedback as well as PUSCH carrying data and possible UCI within the same TXOP acquired by the initiating gNB without the UE performing CCA before PUSCH/PUCCH transmission as long as the gap between downlink and uplink transmission is less than or equal to 16 μs. Operation in this manner is typically called “COT sharing”. FIG. 1 is a schematic diagram showing an example of COT sharing initiated by gNB, which shows TXOP both with and without COT sharing where CCA is performed by the initiating node (gNB). For the case of COT sharing, the gap between downlink and uplink transmission is less than 16 μs.

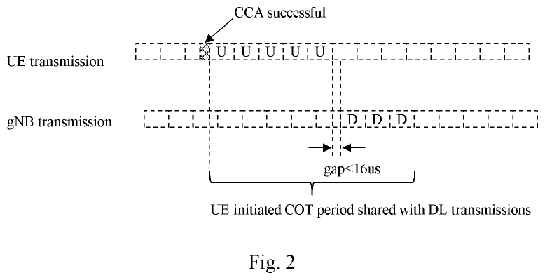

When UE accesses medium via Category-4 (Cat-4) LBT with a configured grant outside of a gNB COT, it is also possible for UE and gNB to share the UE acquired COT to schedule downlink data to the same UE. UE COT information can be indicated in UCI such as CG-UCI (configured grant-uplink control information) for configured grant PUSCH resources. FIG. 2 is a schematic diagram showing an example of COT sharing initiated by UE. For the case of COT sharing, the gap between uplink and downlink transmission is less than 16 μs.

### Dynamic Channel Occupancy by Load Based LBE

Rel 16 WI NR-U specifies a dynamic channel access mechanism for an LBE type device.

This procedure is designed to randomize the start of transmissions from different nodes that want to access the channel at the same time.

This procedure is commonly known as category 4 (CAT4) LBT, the detailed procedure for category 4 LBT (also named as Type 1 channel access in TS 37.213 V 17.0.0) is described as below.

A UE may transmit the transmission using Type 1 channel access procedure after first sensing the channel to be idle during the slot durations of a defer duration T_{d}, and after the counter N is zero in step 4. The counter N is adjusted by sensing the channel for additional slot duration(s) according to the steps described below.
1) set N=Nᵢₙᵢₜ, where Nᵢₙᵢₜ is a random number uniformly distributed between 0 and CWₚ, and go to step 4;
2) if N>0 and the UE chooses to decrement the counter, set N=N−1;
3) sense the channel for an additional slot duration, and if the additional slot duration is idle, go to step 4; else, go to step 5;
4) if N=0, stop; else, go to step 2.
5) sense the channel until either a busy slot is detected within an additional defer duration T_{d} or all the slots of the additional defer duration T_{d} are detected to be idle;
6) if the channel is sensed to be idle during all the slot durations of the additional defer duration T_{d}, go to step 4; else, go to step 5;

If a UE has not transmitted a UL transmission on a channel on which UL transmission(s) are performed after step 4 in the procedure above, the UE may transmit a transmission on the channel, if the channel is sensed to be idle at least in a sensing slot duration Tₛₗ when the UE is ready to transmit the transmission and if the channel has been sensed to be idle during all the slot durations of a defer duration T_{d} immediately before the transmission. If the channel has not been sensed to be idle in a sensing slot duration Tₛₗ when the UE first senses the channel after it is ready to transmit, or if the channel has not been sensed to be idle during any of the sensing slot durations of a defer duration T_{d} immediately before the intended transmission, the UE proceeds to step 1 after sensing the channel to be idle during the slot durations of a defer duration T_{d}.

The defer duration T_{d} consists of duration T_{f}=16 us immediately followed by mₚ consecutive slot durations where each slot duration is Tₛₗ=9 us, and T_{f} includes an idle slot duration Tₛₗ at start of T_{f}.
CW_{min,p}≤CWₚ≤CW_{max,p} is the contention window. CWₚ adjustment is described in clause 4.2.2.
CW_{min,p} and CW_{max,p} are chosen before step 1 of the procedure above.
mₚ, CW_{min, p}, and CW_{max, p} are based on a channel access priority class p as shown in Table 1/Table 4.2.1-1 in TS 37.213 v 17.0.0.

### Semi-Static Channel Occupancy by FBE

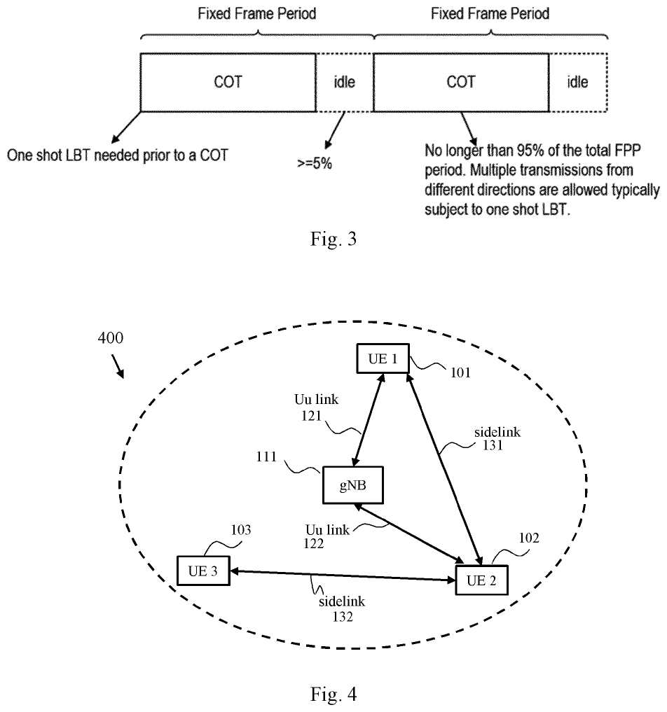

The Semi-static channel occupancy allows a FBE to perform a clear channel assessment per fixed frame period for a duration of single 9 us observation slot. If the channel is found to be busy after CCA operation, the equipment shall not transmit during this fixed frame period. The fixed frame period can be set to a value between 1 and 10 ms and can be adjusted once every 200 ms. If the channel is found to be idle, the equipment can transmit immediately up to a duration referred to as channel occupancy time, after which the equipment shall remain silent for at least 5% of said channel occupancy time. At the end of the required idle period, the equipment can resume CCA for channel access. FIG. 3 shows an example of the FBE based channel occupancy operation.

The Semi-static channel occupancy generally has difficulty competing with devices that use dynamic channel occupancy (such as LAA or NR-U) for channel access. Dynamic channel occupancy device has the flexibility to access the channel at any time after a successful LBT procedure, while the semi-static channel occupancy devices has one chance for grabbing the channel every fixed frame period. The problems become more exacerbated with longer fixed frame period and higher traffic load. Secondly, the frame based LBT can be rather inflexible for coordinating channel access between networks. If all the nodes are synchronized, then all nodes will find the channel available and transmit simultaneously and cause interference. If the nodes are not synchronized, then some nodes may have definitive advantages in getting access to the channel over some other nodes. Nonetheless, semi-static channel occupancy can be good choice for controlled environments, where a network owner can guarantee absence of dynamic channel occupancy devices and is in control of the behavior of all devices competing to access the channel. In fact, in such deployment, semi-static channel occupancy is an attractive solution because access latencies can be reduced to the minimum and lower complexity is required for channel access due to lack of necessity to perform random backoff.

It has been identified that FBE operation for the scenario where it is guaranteed that LBE nodes are absent on a long-term basis (e.g., by level of regulation) and FBE gNBs are synchronized can achieve the following:
Ability to use frequency reuse factor 1;
Lower complexity for channel access due to lack of necessity to perform random backoff.

In order to deploy a single operator FBE system, the gNBs need to be time aligned. All gNBs will perform the one-shot 9 us LBT at the same time. If the gNB indicates FBE operation, for an indication of LBT type of Cat2 25 us or Cat4 the UE follows the mechanism whereby one 9 microsecond slot is measured within a 25-microsecond interval.

The fixed frame period (FFP) is restricted to values of {1 ms, 2 ms, 2.5 ms, 4 ms, 5 ms, 10 ms} (this is including the idle period). The starting positions of the FFPs within every two radio frames starts from an even radio frame and are given by i*P where i= {0,1, . . . , 20/P−1} where P is the fixed frame period in ms.

The idle period for a given SCS=ceil (Minimum idle period allowed by regulations/Ts) where minimum idle period allowed=max (5% of FFP, 100 us), and Ts is the symbol duration for the given subcarrier spacing (SCS).

For FBE, channel sensing is performed at fixed time instants. If the channel is determined busy, the base station adopts a fixed back-off and perform LBT again after the fixed backoff. For LBE, channel sensing can be performed at any time instance, and random back-off is adopted when the channel is determined to be busy.

As described in 3GPP TR 38.889, it has been identified that FBE operation for the scenario where it is guaranteed that LBE nodes are absent on a long term basis (e.g., by level of regulation) and FBE gNBs are synchronized can achieve the following: Ability to use frequency reuse factor 1; Lower complexity for channel access due to lack of necessity to perform random backoff. It is noted that this does not imply that LBE does not have benefits in similar scenarios although there are differences between the two modes of operation. It is also noted that FBE may also have some disadvantages compared to other modes of operation such as LBE, e.g., a fixed overhead for idle time during a frame.

In NR Rel-16, it is only gNB COT sharing is supported in case of semi-static channel access by FBE. A UE may transmit UL transmission burst(s) after DL transmission within a gNB initiated COT. UE transmissions within a fixed frame period can occur if DL transmission for the serving gNB within the fixed frame period are detected. The detection of any DL transmission confirms that the gNB has initiated the COT. For this to work, the UE should be aware of the start and end of every FFP cycle. Such UE behaviors are not optimum for Ultra Reliable Low Latency Communication (URLLC) like services which require critical latency requirements. UE initiated COT by FBE would be a complementary solution for URLLC.

### SideLink Transmission in NR

Sidelink transmissions over NR are specified for 3GPP Release 16. These are enhancements of the ProSe (PROximity-based SErvices) specified for LTE. Four new enhancements are particularly introduced to NR sidelink transmissions as follows:
Support for unicast and groupcast transmissions are added in NR sidelink. For unicast and groupcast, the physical sidelink feedback channel (PSFCH) is introduced for a receiver UE to reply the decoding status to a transmitter UE.
Grant-free transmissions, which are adopted in NR uplink transmissions, are also provided in NR sidelink transmissions, to improve the latency performance.
To alleviate resource collisions among different sidelink transmissions launched by different UEs, it enhances channel sensing and resource selection procedures, which also lead to a new design of PSCCH.
To achieve a high connection density, congestion control and thus the quality of service (QOS) management is supported in NR sidelink transmissions.

To enable the above enhancements, new physical channels and reference signals are introduced in NR (available in LTE before):
PSSCH (Physical Sidelink Shared Channel, SL version of PDSCH): The PSSCH is transmitted by a sidelink transmitter UE, which conveys sidelink transmission data, system information blocks (SIBs) for radio resource control (RRC) configuration, and a part of the sidelink control information (SCI).
PSFCH (Physical Sidelink feedback channel): The PSFCH is transmitted by a sidelink receiver UE for unicast and groupcast, which conveys 1 bit information over 1 resource block for the Hybrid Automatic Repeat request (HARQ) acknowledgement (ACK) and the negative ACK (NACK). In addition, channel state information (CSI) is carried in the medium access control (MAC) control element (CE) over the PSSCH instead of the PSFCH.
PSCCH (Physical Sidelink Common Control Channel, sidelink version of PDCCH): When the traffic to be sent to a receiver UE arrives at a transmitter UE, a transmitter UE should first send the PSCCH, which conveys a part of SCI (Sidelink Control information, sidelink version of DCI) to be decoded by any UE for the channel sensing purpose, including the reserved time-frequency resources for transmissions, demodulation reference signal (DMRS) pattern and antenna port, etc.
Sidelink Primary/Secondary Synchronization Signal (S-PSS/S-SSS): Similar to downlink transmissions in NR, in sidelink transmissions, primary and secondary synchronization signals (called S-PSS and S-SSS, respectively) are supported. Through detecting the S-PSS and S-SSS, a UE is able to identify the sidelink synchronization identity (SSID) from the UE sending the S-PSS/S-SSS. Through detecting the S-PSS/S-SSS, a UE is therefore able to know the characteristics of the UE transmitter the S-PSS/S-SSS. A series of process of acquiring timing and frequency synchronization together with SSIDs of UEs is called initial cell search. Note that the UE sending the S-PSS/S-SSS may not be necessarily involved in sidelink transmissions, and a node (UE/eNB/gNB) sending the S-PSS/S-SSS is called a synchronization source. There are 2 S-PSS sequences and 336 S-SSS sequences forming a total of 672 SSIDs in a cell.
Physical Sidelink Broadcast Channel (PSBCH): The PSBCH is transmitted along with the S-PSS/S-SSS as a synchronization signal/PSBCH block (SSB). The SSB has the same numerology as PSCCH/PSSCH on that carrier, and an SSB should be transmitted within the bandwidth of the configured bandwidth part (BWP). The PSBCH conveys information related to synchronization, such as the direct frame number (DFN), indication of the slot and symbol level time resources for sidelink transmissions, in-coverage indicator, etc. The SSB is transmitted periodically at every 160 ms.
DMRS, phase tracking reference signal (PT-RS), channel state information reference signal (CSIRS): These physical reference signals supported by NR downlink/uplink transmissions are also adopted by sidelink transmissions. Similarly, the PT-RS is only applicable for FR2 transmission.

Another new feature is the two-stage sidelink control information (SCI). This is a version of the DCI for sidelink. Unlike the DCI, only part (first stage) of the SCI is sent on the PSCCH. This part is used for channel sensing purposes (including the reserved time-frequency resources for transmissions, DMRS pattern and antenna port, etc.) and can be read by all UEs while the remaining (second stage) scheduling and control information such as a 8-bits source identity (ID) and a 16-bits destination ID, NDI, RV and HARQ process ID is sent on the PSSCH to be decoded by the receiver UE.

Similar as for PROSE in LTE, NR sidelink transmissions have the following two modes of resource allocations:
Mode 1: Sidelink resources are scheduled by a gNB.
Mode 2: The UE autonomously selects sidelink resources from a (pre-) configured sidelink resource pool(s) based on the channel sensing mechanism.

For the in-coverage UE, a gNB can be configured to adopt Mode 1 or Mode 2. For the out-of-coverage UE, only Mode 2 can be adopted.

As in LTE, scheduling over the sidelink in NR is done in different ways for Mode 1 and Mode 2.

Mode 1 supports the following two kinds of grants:

Dynamic grant: When the traffic to be sent over sidelink arrives at a transmitter UE, this UE should launch the four-message exchange procedure to request sidelink resources from a gNB (SR on uplink, grant, BSR (buffer status report) on uplink, grant for data on sidelink sent to UE). During the resource request procedure, a gNB may allocate a sidelink radio network temporary identifier (SL-RNTI) to the transmitter UE. If this sidelink resource request is granted by a gNB, then a gNB indicates the resource allocation for the PSCCH and the PSSCH in the DCI conveyed by PDCCH with Cyclic Redundancy Check (CRC) scrambled with the SL-RNTI. When a transmitter UE receives such a DCI, a transmitter UE can obtain the grant only if the scrambled CRC of DCI can be successfully solved by the assigned SL-RNTI. A transmitter UE then indicates the time-frequency resources and the transmission scheme of the allocated PSSCH in the PSCCH, and launches the PSCCH and the PSSCH on the allocated resources for sidelink transmissions. When a grant is obtained from a gNB, a transmitter UE can only transmit a single TB (transport block). As a result, this kind of grant is suitable for traffic with a loose latency requirement.

Configured grant: For the traffic with a strict latency requirement, performing the four-message exchange procedure to request sidelink resources may induce unacceptable latency. In this case, prior to the traffic arrival, a transmitter UE may perform the four-message exchange procedure and request a set of resources. If a grant can be obtained from a gNB, then the requested resources are reserved in a periodic manner. Upon traffic arriving at a transmitter UE, this UE can launch the PSCCH and the PSSCH on the upcoming resource occasion. In fact, this kind of grant is also known as grant-free transmissions.

In both dynamic grant and configured grant, a sidelink receiver UE cannot receive the DCI (since it is addressed to the transmitter UE), and therefore a receiver UE should perform blind decoding to identify the presence of PSCCH and find the resources for the PSSCH through the SCI.

When a transmitter UE launches the PSCCH, CRC is also inserted in the SCI without any scrambling.

In the Mode 2 resource allocation, when traffic arrives at a transmitter UE, this transmitter UE should autonomously select resources for the PSCCH and the PSSCH. To further minimize the latency of the feedback HARQ ACK/NACK transmissions and subsequently retransmissions, a transmitter UE may also reserve resources for PSCCH/PSSCH for retransmissions. To further enhance the probability of successful TB (transport block) decoding at one shot and thus suppress the probability to perform retransmissions, a transmitter UE may repeat the TB transmission along with the initial TB transmission. This mechanism is also known as blind retransmission. As a result, when traffic arrives at a transmitter UE, then this transmitter UE should select resources for the following transmissions:
1) The PSSCH associated with the PSCCH for initial transmission and blind retransmissions.
2) The PSSCH associated with the PSCCH for retransmissions.

Since each transmitter UE in sidelink transmissions should autonomously select resources for above transmissions, how to prevent different transmitter UEs from selecting the same resources turns out to be a critical issue in Mode 2. A particular resource selection procedure is therefore imposed to Mode 2 based on channel sensing. The channel sensing algorithm involves measuring RSRP on different subchannels and requires knowledge of the different UEs power levels of DMRS on the PSSCH or the DMRS on the PSCCH depending on the configuration. This information is known only after receiver SCI launched by (all) other UEs. The sensing and selection algorithm is rather complex.

For next 3GPP releases, Sidelink transmission on unlicensed spectrum is a new technology which is attracting strong interest from companies.

In order to support sidelink transmission on unlicensed spectrum (SL-U), similar channel access mechanism as in NR-U need to be introduced for SL-U. With channel access mechanism, a SL capable UE may need to perform LBT operation prior to a SL transmission. However, LBT operation will cause transmission latency for the SL transmission. In this case, the COT sharing mechanism similar as in NR-U would be beneficial to be also supported for SL-U.

However, the existing COT sharing mechanism in NR-U cannot be directly reused for SL-U. In NR-U, COT sharing enables a UE to share a UL COT with the gNB (i.e., so called UL COT sharing) or enables the gNB to share a DL COT with one or multiple UEs (i.e., so called DL COT sharing). In SL-U, COT sharing mechanism shall be able to enable a COT to be shared between SL UEs. In P103146, mechanisms on how to enable COT sharing between UEs and/or gNBs for SL-U is covered.

It is expected that there may be two ways to enable COT sharing for two more UEs which are involved with SL transmission on unlicensed hand.
Option 1: UE initiated/enabled COT sharing. In this case, a UE can determine whether to share a COT initiated by itself with other SL UEs.
Option 2: gNB instructed/enabled COT sharing. In this case, gNB of SL UEs may determine to enable a COT to share between two or more SL UEs on unlicensed band. In this option, gNB may base on information reported by UEs to allocate SL resources for the COT.

For Option 1, the gNB of SL UEs will not be aware whether or when a COT is being shared between SL UEs. This would cause the following issue

Issue: in case of Mode 1 scheduling, the gNB may assign a SL grant to a SL UE, which is being involved in one or multiple COTs. Due to lacking knowledge of information on scheduling/resources of these COT, the SL grant may be outside of the COT period. In this case, the UE would have to perform LBT operation in order to grasp the channel. If LBT operation fails, the UE would not be able to use the grant, and cause resource wastage.

Therefore, it is necessary to study the above issue and develop corresponding solutions.

Mechanisms are proposed to enable a SL UE to report COT scheduling information to the gNB so that the gNB can schedule/allocate the UE with SL resources considering the COT scheduling information. In this way, the UE may be allowed to skip LBT operation during a COT.

With proposed mechanisms, we can achieve the following benefits:
1) The frequency of LBT operation can be minimized;
2) Latency is reduced due to fewer LBT operation;
3) Channel utilization ratio is improved due to that multiple UEs are allowed to share the channel;
4) QOS satisfaction of services are improved.

The embodiments are described in the context of NR, i.e., two or more SL UEs are deployed in a same or different NR cell. However, the same principle may be applied to LTE or any other technology that enables the direct connection of two (or more) nearby devices. The embodiments are also applicable to relay scenarios including UE to network relay or UE to UE relay where the remote UE and the relay UE may be based on LTE sidelink or NR sidelink, the Uu connection between the relay UE and the base station may be LTE Uu or NR Uu.

The proposed mechanism is applicable to SL unlicensed operations (i.e., SL transmission on unlicensed band). The term LBT may also interchangeably called as clear channel assessment (CCA), shared spectrum access procedure etc. The carrier on which the LBT is applied may belong to a shared spectrum or an unlicensed band or band with contention based access etc.

In addition, both LBE based channel access schemes (may also be named as dynamic channel access) and FBE based channel access schemes (may also be named as semi static channel access) are covered in the following embodiments.

The following embodiments are applicable to SL transmissions on unlicensed band with any cast type including unicast, groupcast and broadcast.

For a SL BWP configured to the UE, the BWP may contain multiple bandwidth segments referred to as e.g., channel, sub-band, BWP segment etc., for each segment, it may be configured with the following different parameters:
SCS
Symbol duration
Cyclic prefix (CP) length.

In this case, the UE may perform LBT operation per channel/subband/BWP segment.

FIG. 4 is a schematic block diagram showing a communication system 300, in which the embodiments herein can be implemented.

In an embodiment, the communication system 300 may include a plurality of UEs (such as the UE 101, 102, and 103) and a base node (such as the gNB 111). The link over Uu interface (such as Uu link 121, 122) has been established between the UEs 101, 102 and the gNB 111, and sidelink (also called direct connection) (such as sidelink 131, 132) has been established between the UEs 101, 102 and 103.

As an embodiment, for a SL UE which is involved with one or multiple COT periods for SL transmission or reception on unlicensed band, the UE needs to signal the COT scheduling information to the gNB based on which the gNB can schedule SL resources according to knowledge of the COT scheduling information, i.e., schedule the resources within the COT period to avoid unnecessary LBT operation initiated by the UE when performing SL transmission using the resources.

The UE signals the COT scheduling information to its serving gNB via at least one of the following signalling alternatives

In an embodiment, the UE initiates a RACH procedure.

A 4-step RA can be triggered to indicate the COT scheduling information to the gNB.

In an example, Msg1 is used to indicate the COT scheduling information. A dedicated preamble or dedicated RACH occasions may be allocated to the UE for indicating the request. The allocation may be pre-defined, determined based on a pre-defined rule, or configured by the gNB.

In an example, Msg3 is extended to indicate the COT scheduling information. In Msg3, the UE MAC entity adds an indicator indicating the COT scheduling information. The indicator may be a field in the MAC subheader or carried in a MAC CE.

A 2-step RA can be triggered to indicate the COT scheduling information. A dedicated preamble or dedicated RACH occasions or dedicated PUSCH occasions/resources may be allocated to the UE for indicating the COT scheduling information. Alternatively, indicators indicating the information can be included in MsgA payload. The indicator may be a field in the MAC subheader or carried in a MAC CE. In this option, the UE may use a MAC CE to report the COT scheduling information to the gNB. The MAC CE may be an existing MAC CE e.g., BSR, or newly introduced for reporting the COT scheduling information.

Alternatively, an RRC message (partly or fully) may be included in a RACH message, which includes the COT scheduling information.

In an embodiment, the UE initiates a PUCCH transmission for indicting the COT scheduling information. Separate dedicated PUCCH resources may be configured to the UE for indicating the COT scheduling information accordingly.

In an embodiment, the UE initiates a PUSCH based transmission, such as a configured grant-based transmission or a dynamic grant based transmission for indicting the COT scheduling information. For indicating the information, separate dedicated configured grant resources may be configured to the UE accordingly. Alternatively, indicators for indicating the COT scheduling information may be included in the CG-UCI. In this embodiment, the UE may use RRC signaling to report the COT scheduling information to the gNB. The RRC signaling may comprise for example RRC reconfiguration, UE assistance information, UE information response upon reception of a request from the gNB, Sidelink UE information for NR sidelink communication, RRC measurement report or any other RRC signaling message which is feasible for the UE to report the COT scheduling information to the gNB.

In this embodiment, the UE may use a MAC CE to report the COT scheduling information to the gNB. The MAC CE may be an existing MAC CE e.g., BSR, or newly introduced for reporting the COT scheduling information.

In an embodiment, the UE initiates an SRS transmission for indicting the COT scheduling information. For indicating the COT scheduling information, separate dedicated SRS resources may be configured to the UE accordingly.

Specifically, as an additional example to Option 2 and Option 3, the UE can indicate the COT scheduling information in a PUCCH-UCI which can be carried in PUCCH or multiplexed with PUSCH.

For any one of the above signaling options, COT scheduling information carried in a signaling may comprise at least one of the following information:
One or multiple UE IDs which indicate which UE has reported the COT scheduling information.
   In an example, UE IDs are the IDs associated with the UE for Uu communication, e.g., C-RNTI, Resume ID, International Mobile Subscriber Identity (IMSI), Temporary Mobile Subscriber Identity (TMSI), Globally Unique Temporary UE Identity (GUTI) or any random ID which is allocated to the UE for Uu communication
   In an example, UE IDs are the IDs associated with the UE for SL communication, e.g., L2 ID, L1 ID or any random ID which is allocated to the UE for Uu communication.
One or multiple COT periods which are associated with the UE
   For each of the COT period, the signaling comprises one of the following
      One or multiple IDs of the initiating UE or node of the COT, i.e., who has initiated the COT.
         Similar IDs as the UE which reports the COT scheduling information may be reported for the initiating UE/node (e.g., Uu IDs or SL L2 IDs)
      One or multiple IDs of the destination UEs towards which the reporting UE may initiate SL transmission.
         Similar IDs as the UE which reports the COT scheduling information may be reported for the destination UEs (e.g., Uu IDs or SL L2 IDs)
      Purpose/usage of the COT for the UE (i.e., transmission only, reception only or both transmission and reception)
      Start time and/or end time of the COT in time domain
      Frequency region or physical resource block (PRB) set associated with the COT, i.e., what frequency resources can be used for transmission or reception for the UE within the COT
      Channel access types (e.g., category 1, 2, 3 or 4, and/or associated channel access priority classes) which are allowed for UE prior to a SL transmission within the COT
         Channel access modes (e.g., LBE or FBE) which are allowed for UE prior to a SL transmission within the COT
         COT duration/remaining COT duration of the COT
         Services, traffic types, radio bearers, logical channels, logical channel groups which are allowed by the UE for transmission or reception within the COT
         Priority information, or QoS requirements associated with transmission or reception are allowed by the UE within the COT
         Destination IDs of SL transmission or reception associated with the COT and allowed by the UE

As an embodiment, for a SL UE which is involved with one or multiple COT periods for SL transmission or reception on unlicensed band, the UE may send signaling carrying COT scheduling information to the gNB via at least one of the following fashions:
Periodical reporting, one or multiple periodical timers may be defined accordingly
Event triggering which may comprise one of the following events
   When the UE has initiated a COT;
   When the UE has received information or signaling which allow the UE to share a COT which is initiated by other nodes (e.g., UE, or gNB);
   Any parameter (as described in the first embodiment) associated with a COT has changed;
   When triggering or sending a SR or BSR by the UE to the gNB for requesting SL resources;
   Upon reception of a request message from the gNB for requesting the COT scheduling information.

As an embodiment, for a SL UE which is involved with one or multiple COT periods for SL transmission or reception on unlicensed band, for a reported COT to the gNB, the COT may be initiated by the UE.

As an embodiment, for a SL UE which is involved with one or multiple COT periods for SL transmission or reception on unlicensed band, for a reported COT to the gNB, the COT may be initiated by another UE, in this case, the UE receives the COT scheduling information from the other UE which has initiated the COT. The COT scheduling information is exchanged between UEs via at least one of the following signaling alternatives on the SL interface:
RRC signaling (e.g., PC5-RRC)
PC5-S signaling
MAC CE
Control packet data unit (PDU) of a protocol layer (e.g., Service Data Adaptation Protocol (SDAP), Packet Data Convergence Protocol (PDCP), Radio Link Control (RLC) or an adaptation layer which is response for relaying purpose)
L1 signaling on physical channels (including PSSCH, PSCCH, PSFCH etc)

As a fifth embodiment, for a UE pair (e.g., UE1 and UE2) involved in SL transmission or reception on unlicensed band, there may be separate COTs associated to the UE pair for different directions. In other words, there may be different COTs for the direction from UE1 to UE2, and the direction from UE2 to UE1. Therefore a COT would be directional.

In an example, COT 1 is associated with the transmission direction from UE1 to UE2. COT 1 will be mainly used by UE1 for performing SL transmission to UE2. In addition, UE2 may be allowed to provide acknowledgement or status message using COT 1 upon reception of SL transmission from UE1.

In addition, COT 2 is associated with the transmission direction from UE2 to UE1. COT 2 will be mainly used by UE2 for performing SL transmission to UE1. In addition, UE1 may be allowed to provide acknowledgement or status message using COT 2 upon reception of SL transmission from UE2.

For a COT which is directional (e.g., from UEI to UE2), UE2 operates as receiving UE for the COT. UE2 may be only allowed to transmit acknowledgement (e.g., HARQ acknowledgement or upper layer acknowledgement (e.g., RLC, PDCP, SDAP, RRC etc) message to UE1 within the COT. In this case, in order to perform other transmissions to UE1, UE2 may need to obtain a COT which covers the direction from UE2 to UE1.

Alternatively, a COT is bidirectional for the UE pair. So, UEl or UE2 can freely initiate SL transmission towards its peer UE within the COT, may skipping LBT operation prior to the SL transmission.

As an embodiment, when a gNB receives a signaling from a UE for reporting COT scheduling information, the gNB may schedule/allocate SL resources to the UE considering the reported COT scheduling information.

More specifically, the gNB may schedule the UE with higher priority than other UEs. The UE will be scheduled more often and will be allocated with more SL resources compared to other UEs. In this way, the UE will be able to perform more SL transmissions during a COT may skipping LBT operations.

The gNB would only schedule/allocate SL resources to the UE for a COT if the COT allows the UE to perform SL transmission.

As an embodiment, when a gNB receives a signaling from a UE for reporting COT scheduling information, the gNB may forward/report the signaling to another gNB via inter-gNB interface/signaling. Considering the reported COT scheduling information, the other gNB may schedule/allocate SL resources to the UEs which are allowed to share the COT. More specifically, the other gNB may schedule the UEs with higher priority. The UEs will be scheduled more often and will be allocated with more SL resources compared to other UEs. In this way, the UEs will be able to perform more SL transmissions during a COT may skipping LBT operations.

The gNB would only schedule/allocate SL resources to the UE for a COT if the COT allows the UE to perform SL transmission.

As an embodiment, a UE may be configured with multiple gNBs (i.e., the UE has multiple serving gNBs), which are all allowed to control the UE's SL transmission towards other SL UEs, in this case, the UE may provide COT scheduling information to one or multiple of those gNBs. One or multiple of those gNBs may schedule/allocate SL resources to the UE upon reception of COT scheduling information, wherein different serving gNB may provide SL resources in different frequency regions (e.g., in different bandwidth segments of the carrier, or in different carriers) to the UE.

Upon reception of COT scheduling information from the UE, a serving gNB of the UE may forward the COT scheduling information to another serving gNB of the UE.

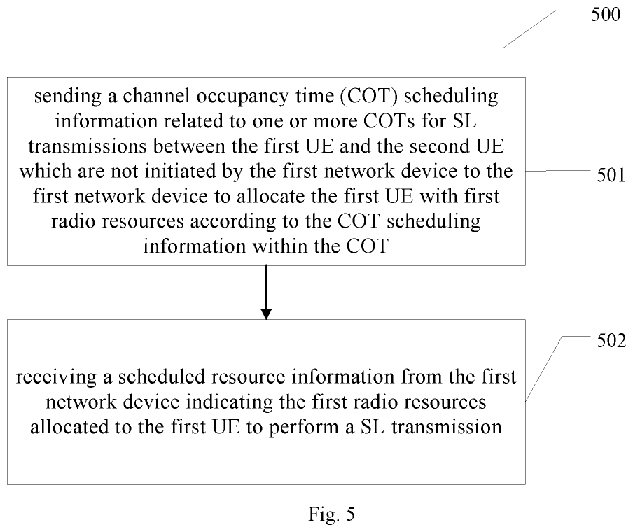

FIG. 5 illustrates an exemplary flow diagram 500 for a method implemented by a first UE for channel occupancy time scheduling information sharing for SL transmission on unlicensed band according to one or more embodiments of the present disclosure. The first UE is in communication with a first network device and a second UE. The second UE may include one or more UEs. In an embodiment, the COT may be shared between the first UE, and more than one second UEs. In an example, the COT may be shared between the first UE and a group of receiving UEs. With reference to FIG. 5, in step 501, the first UE may send a COT scheduling information related to one or more COTs for SL transmissions between the first UE and the second UE which are not initiated by the first network device to the first network device to allocate the first UE with first radio resources according to the COT scheduling information within the COT.

In step 502, the first UE may receive a scheduled resource information from the first network device indicating the first radio resources allocated to the first UE to perform a sidelink (SL) transmission.

In an embodiment, the COT scheduling information may include one or more of the following:
one or more UE identifications (IDs) of the first UE which has sent the COT scheduling information; or
one or more COT periods associated with the first UE.

In an embodiment, the one or more UE IDs may include the IDs associated with the first UE for Uu communication.

In an embodiment, the one or more UE IDs may include the IDs associated with the first UE for SL communication.

In an embodiment, for each of the one or more COTs, the COT scheduling information may include one or more of the following:
one or more IDs of the initiating UE or node of the COT;
one or more IDs of the destination UEs of the COT towards which the initiating UE may initiate SL transmission;
transmission direction of the COT for the first UE;
start time and/or end time of the COT;
frequency resources which can be used for transmission for the first UE within the COT;
channel access types which are allowed for the first UE prior to a SL transmission within the COT;
channel access modes which are allowed for the first UE prior to a SL transmission within the COT;
COT duration or remaining COT duration of the COT;
services, traffic types, radio bearers, logical channels, logical channel groups which are allowed by the UE for transmission within the COT;
priority information, or QOS requirements associated with transmission which are allowed by the first UE within the COT; or
destination IDs of SL transmission associated with the COT and allowed by the UE.

In an embodiment, the COT scheduling information may be sent to the first device via a Random Access Channel (RACH) message.

In an embodiment, the RACH message may include a radio resource control (RRC) message which carries the COT scheduling information.

In an embodiment, the COT scheduling information may be sent to the first device via a Physical Uplink Control Channel (PUCCH) transmission.

In an embodiment, the COT scheduling information may be sent to the first device via a Physical Uplink Shared Channel (PUSCH) transmission.

In an embodiment, the COT scheduling information may be sent via an RRC signaling.

In an embodiment, the COT scheduling information may be sent via a medium access control (MAC) control element (CE).

In an embodiment, the COT scheduling information may be sent to the first device via an Sounding Reference Signal (SRS) transmission.

In an embodiment, the COT scheduling information may be sent periodically to the first network device.

In an embodiment, the COT scheduling information is sent when one of the following events occurs:
the first UE has initiated the COT;
the first UE has received information regarding a COT which is initiated by other nodes;
any parameter associated with the COT has changed; or
triggering or sending an schedule request (SR) or buffer status report (BSR) by the first UE to the first network device for requesting SL resources.

In an embodiment, the COT scheduling information may send upon reception of a request message from the first network device for requesting the COT scheduling information.

In an embodiment, wherein one of the one or more COT may be initiated by the first UE.

In an embodiment, wherein one of the one or more COT may be initiated by the second UE, and the method may further comprise receiving a channel occupancy time (COT) scheduling information for the COT initiated by the second UE; and sending the channel occupancy time (COT) scheduling information for the COT initiated by the second UE to the first network device.

In an embodiment, the COT scheduling information for the COT initiated by the second UE may be received via at least one of the following signaling:
RRC signaling;
PC5-S signaling;
MAC CE;
Control packet data unit (PDU) of a protocol layer; or
L1 signaling on physical channels.

In an embodiment, the one or more COTs are directional.

In an embodiment, one of the one or more COTs is used for the transmission direction from the first UE to the second UE.

In an embodiment, one of the one or more COTs is used for the transmission direction from the second UE to the first UE.

In an embodiment, one of the one or more COTs is bidirectional for the transmission between the first UE and the second UE.

In an embodiment, the first UE may be connected to a second network device, and the method may further comprise sending the COT scheduling information to the second network device to allocate the first UE with second radio resources according to the COT scheduling information within the COT; and receiving a scheduled resource information from the first network device indicating the second radio resources allocated to the first UE to perform an SL transmission.

In an embodiment, the second radio resources allocated by the second network device are different from the first radio resources allocated by the first network device.

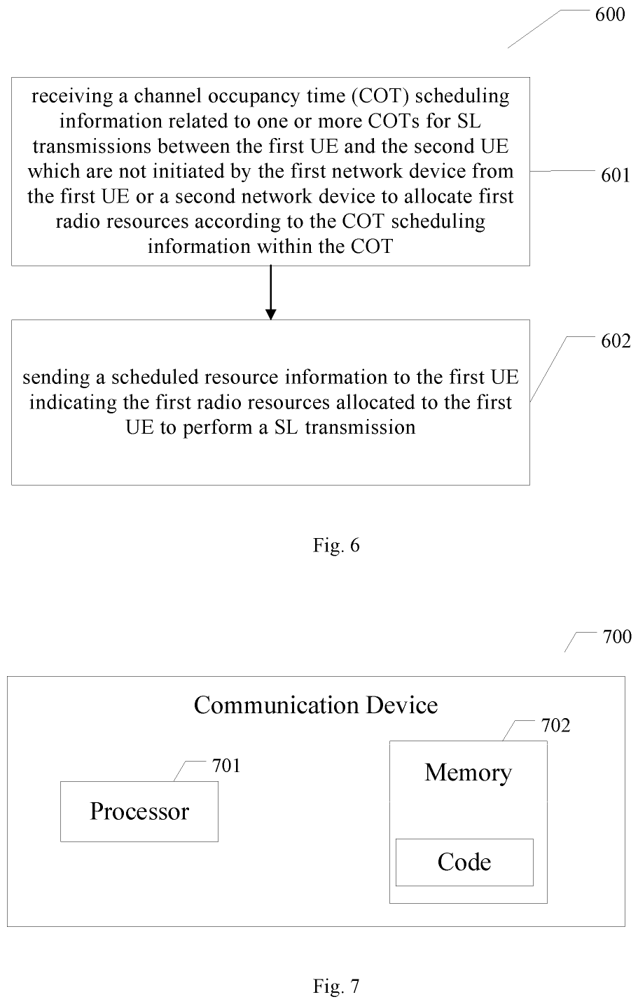

FIG. 6 illustrates an exemplary flow diagram 600 for a method implemented by a first network device for channel occupancy time scheduling information sharing for SL transmission on unlicensed band according to one or more embodiments of the present disclosure. The first network device is connected to a first UE. The first UE is in communication with the first network device and a second UE. The second UE may include one or more UEs. In an embodiment, the COT may be shared between the first UE, and more than one second UEs. In an example, the COT may be shared between the first UE and a group of receiving UEs.

With reference to FIG. 6, in step 601, the first network device may receive a COT scheduling information related to one or more COTs for SL transmissions between the first UE and the second UE which are not initiated by the first network device from the first UE or a second network device to allocate first radio resources according to the COT scheduling information within the COT. In step 602, the first network device may send a scheduled resource information to the first UE indicating the first radio resources allocated to the first UE to perform a SL transmission.

In an embodiment, the method may further comprise assigning a higher priority to the first UE than other UEs connected to the first network device.

In an embodiment, the method may further comprise forwarding the COT scheduling information to a third network device to allocate radio resources to one or more UEs which can share the one or more COTs.

FIG. 7 is a block diagram illustrating a communication device 700 according to some embodiments of the present disclosure. It should be appreciated that the communication device 700 may be implemented using components other than those illustrated in FIG. 7.

With reference to FIG. 7, the communication device 700 may comprise at least a processor 701, a memory 702, an interface and a communication medium. The processor 701, the memory 702 and the interface are communicatively coupled to each other via the communication medium.

The processor 701 includes one or more processing units. A processing unit may be a physical device or article of manufacture comprising one or more integrated circuits that read data and instructions from computer readable media, such as the memory 702, and selectively execute the instructions. In various embodiments, the processor 701 is implemented in various ways. As an example, the processor 701 may be implemented as one or more processing cores. As another example, the processor 701 may comprise one or more separate microprocessors. In yet another example, the processor 701 may comprise an application-specific integrated circuit (ASIC) that provides specific functionality. In yet another example, the processor 701 provides specific functionality by using an ASIC and by executing computer-executable instructions.

The memory 702 includes one or more computer-usable or computer-readable storage medium capable of storing data and/or computer-executable instructions. It should be appreciated that the storage medium is preferably a non-transitory storage medium.

The communication medium facilitates communication among the processor 701, the memory 702 and the interface. The communication medium may be implemented in various ways. For example, the communication medium may comprise a Peripheral Component Interconnect (PCI) bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing System Interface (SCSI) interface, or another type of communications medium. The interface could be coupled to the processor. Information and data as described above in connection with the methods may be sent via the interface.

In the example of FIG. 7, the instructions stored in the memory 702 may include those that, when executed by the processor 701, cause the communication device 700 to implement the methods described with respect to FIGS. 5-6.

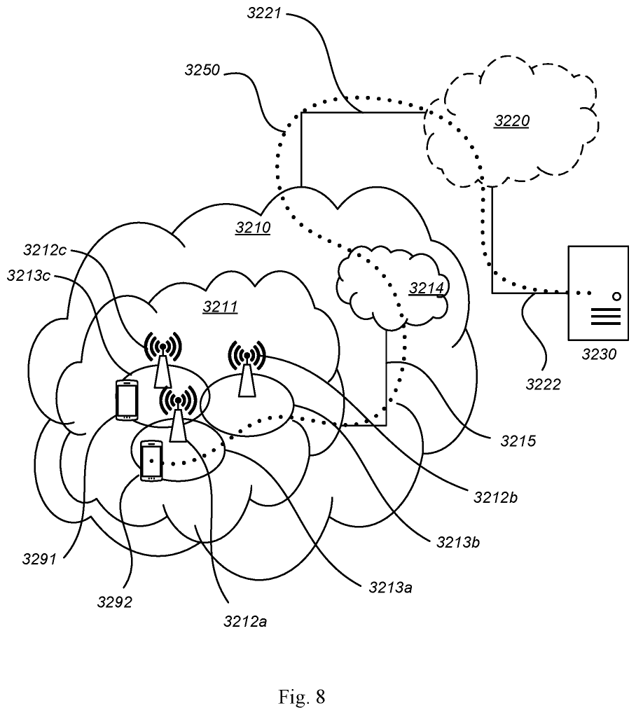

With reference to FIG. 8, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first UE 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 8 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

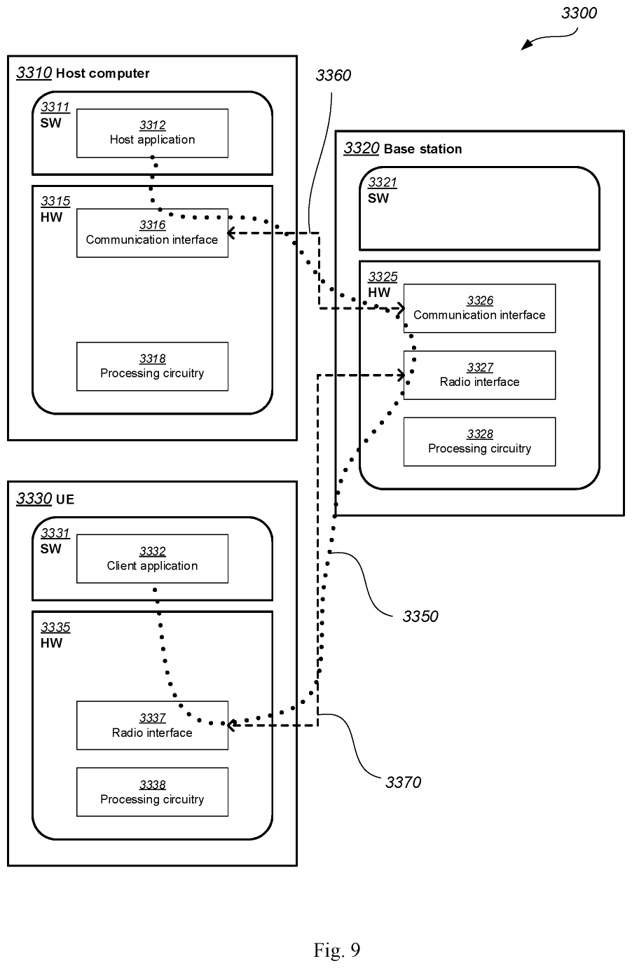

Example implementations, in accordance with an embodiment, of the UE, base station and host computer discussed in the preceding paragraphs will now be described with reference to FIG. 9. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 9) served by the base station 3320. The communication interface 3326 may be configured to facilitate a connection 3360 to the host computer 3310. The connection 3360 may be direct or it may pass through a core network (not shown in FIG. 9) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 9 may be identical to the host computer 3230, one of the base stations 3212a, 3212b, 3212c and one of the UEs 3291, 3292 of FIG. 9, respectively. This is to say, the inner workings of these entities may be as shown in FIG. 9 and independently, the surrounding network topology may be that of FIG. 8.

In FIG. 9, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure One or more of the various embodiments improve the performance of OTT services provided to the UE 3330 using the OTT connection 3350, in which the wireless connection 3370 forms the last segment. More precisely, the teachings of these embodiments may improve the latency and power consumption and thereby provide benefits such as reduced user waiting time, better responsiveness, extended battery lifetime.

A measurement procedure may be provided for the purpose of monitoring data rate, latency, and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency, and the like. The measurements may be implemented in that the software 3311, 3331 causes messages to be transmitted, in particular empty or ‘dummy’ messages, using the OTT connection 3350 while it monitors propagation times, errors etc.

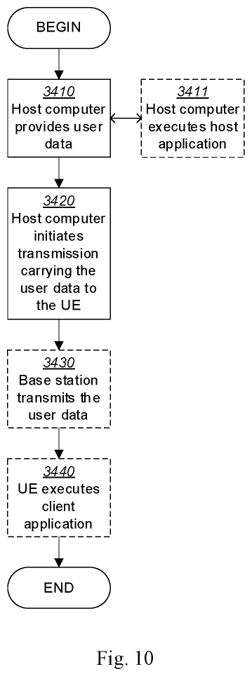

FIG. 10 is a flowchart illustrating a method implemented in a communication system, in accordance with one embodiment. The communication system includes a host computer, a base station and a UE which may be those described with reference to FIG. 8 and FIG. 9. For simplicity of the present disclosure, only drawing references to FIG. 10 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

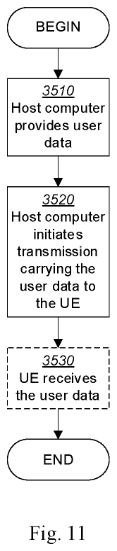

FIG. 11 is a flowchart illustrating a method implemented in a communication system, in accordance with one embodiment. The communication system includes a host computer, a base station and a UE which may be those described with reference to FIG. 9 and FIG. 10. For simplicity of the present disclosure, only drawing references to FIG. 11 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

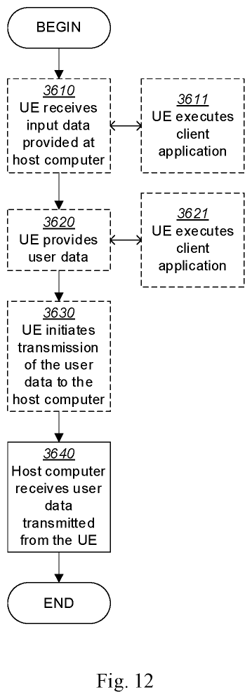

FIG. 12 is a flowchart illustrating a method implemented in a communication system, in accordance with one embodiment. The communication system includes a host computer, a base station and a UE which may be those described with reference to FIG. 8 and FIG. 9. For simplicity of the present disclosure, only drawing references to FIG. 12 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

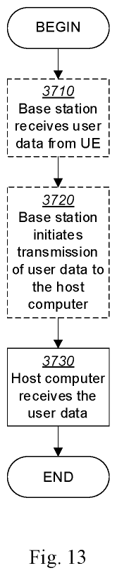

FIG. 13 is a flowchart illustrating a method implemented in a communication system, in accordance with one embodiment. The communication system includes a host computer, a base station and a UE which may be those described with reference to FIG. 8 and FIG. 9. For simplicity of the present disclosure, only drawing references to FIG. 13 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

Some portions of the foregoing detailed description have been presented in terms of algorithms and symbolic representations of transactions on data bits within a computer memory. These algorithmic descriptions and representations are ways used by those skilled in the data processing arts to most effectively convey the substance of their work to others skilled in the art. An algorithm is here, and generally, conceived to be a self-consistent sequence of transactions leading to a desired result. The transactions are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be appreciated, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to actions and processes of a computer system, or a similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the required method transactions. The required structure for a variety of these systems will appear from the description above. In addition, embodiments of the present disclosure are not described with reference to any particular programming language. It should be appreciated that a variety of programming languages may be used to implement the teachings of embodiments of the present disclosure as described herein.

An embodiment of the present disclosure may be an article of manufacture in which a non-transitory machine-readable medium (such as microelectronic memory) has stored thereon instructions (e.g., computer code) which program one or more data processing components (generically referred to here as a “processor”) to perform the operations described above. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In the foregoing detailed description, embodiments of the present disclosure have been described with reference to specific exemplary embodiments thereof. It will be evident that various modifications may be made thereto without departing from the spirit and scope of the present disclosure as set forth in the following claims. The specification and drawings are, accordingly, to be regarded in an illustrative sense rather than a restrictive sense.

Throughout the description, some embodiments of the present disclosure have been presented through flow diagrams. It should be appreciated that the order of transactions and transactions described in these flow diagrams are only intended for illustrative purposes and not intended as a limitation of the present disclosure. One having ordinary skill in the art would recognize that variations can be made to the flow diagrams without departing from the spirit and scope of the present disclosure as set forth in the following claims.

1. A method implemented by a first user equipment (UE) in a communication network, the first UE is in communication with a first network device and a second UE, the method comprising:
sending a channel occupancy time (COT) scheduling information related to one or more COTs for sidelink (SL) transmissions between the first UE and the second UE which are not initiated by the first network device to the first network device to allocate the first UE with first radio resources according to the COT scheduling information within the COT; and
receiving a scheduled resource information from the first network device indicating the first radio resources allocated to the first UE to perform a SL transmission.

2. The method of claim 1, wherein the COT scheduling information includes one or more of the following:
one or more UE identifications (IDs) of the first UE which has sent the COT scheduling information; or
one or more COT periods associated with the first UE.

3. The method of claim 2, wherein the one or more UE IDs include the IDs associated with the first UE for Uu communication; or
wherein the one or more UE IDs include the IDs associated with the first UE for SL communication.

4. (canceled)

5. The method of claim 2, wherein for each of the one or more COTs, the COT scheduling information includes one or more of the following:
one or more IDs of the initiating UE or node of the COT;
one or more IDs of the destination UEs of the COT towards which the initiating UE may initiate SL transmission;
transmission direction of the COT for the first UE;
start time and/or end time of the COT;
frequency resources which can be used for transmission for the first UE within the COT;
channel access types which are allowed for the first UE prior to a SL transmission within the COT;
channel access modes which are allowed for the first UE prior to a SL transmission within the COT;
COT duration or remaining COT duration of the COT;
services, traffic types, radio bearers, logical channels, logical channel groups which are allowed by the UE for transmission within the COT;
priority information, or QoS requirements associated with transmission which are allowed by the first UE within the COT; or
destination IDs of SL transmission associated with the COT and allowed by the UE.

6. The method of claim 1, wherein the COT scheduling information is sent to the first device via at least one of: a Random Access Channel (RACH) message; a Physical Uplink Control Channel (PUCCH) transmission; a Physical Uplink Shared Channel (PUSCH) transmission; an RRC signaling; a medium access control (MAC) control element (CE); or a Sounding Reference Signal (SRS) transmission.

7. The method of claim 6, wherein the RACH message includes a radio resource control (RRC) message which carries the COT scheduling information.

8-12. (canceled)

13. The method of claim 1, wherein the COT scheduling information is sent periodically to the first network device.

14. The method of claim 1, wherein the COT scheduling information is sent when one of the following events occurs:
the first UE has initiated the COT;
the first UE has received information regarding a COT which is initiated by other nodes;
any parameter associated with the COT has changed; or
triggering or sending a schedule request (SR) or buffer status report (BSR) by the first UE to the first network device for requesting SL resources.

15. The method of claim 1, wherein the COT scheduling information is sent upon reception of a request message from the first network device for requesting the COT scheduling information.

16. The method of claim 1, wherein one of the one or more COT is initiated by the first UE.

17. The method of claim 1, wherein one of the one or more COT is initiated by the second UE, and the method comprising:
receiving a channel occupancy time (COT) scheduling information for the COT initiated by the second UE; and
sending the channel occupancy time (COT) scheduling information for the COT initiated by the second UE to the first network device.

18. The method of claim 17, wherein the COT scheduling information for the COT initiated by the second UE is received via at least one of the following signaling:
RRC signaling;
PC5-S signaling;
MAC CE;
Control packet data unit (PDU) of a protocol layer; or
L1 signaling on physical channels.

19. The method of claim 1, wherein the one or more COTs are directional.

20. The method of claim 19, wherein one of the one or more COTs is used for the transmission direction from the first UE to the second UE; the transmission direction from the second UE to the first UE; or bidirectional for the transmission between the first UE and the second UE.

21-22. (canceled)

23. The method of claim 1, wherein the first UE is connected to a second network device, and the method further comprising:
sending the COT scheduling information to the second network device to allocate the first UE with second radio resources according to the COT scheduling information within the COT; and
receiving a scheduled resource information from the first network device indicating the second radio resources allocated to the first UE to perform an SL transmission.

24. The method of claim 23, wherein the second radio resources allocated by the second network device are different from the first radio resources allocated by the first network device.

25. A method implemented by a first network device in a communication network, the first network device is connected to a first user equipment (UE), the first UE is in communication with the first network device and a second UE, the method comprising:
receiving a channel occupancy time (COT) scheduling information related to one or more COTs for sidelink (SL) transmissions between the first UE and the second UE which are not initiated by the first network device from the first UE or a second network device to allocate first radio resources according to the COT scheduling information within the COT; and
sending a scheduled resource information to the first UE indicating the first radio resources allocated to the first UE to perform a SL transmission.

26. The method of claim 25, comprising:
assigning a higher priority to the first UE than other UEs connected to the first network device.

27. The method of claim 26, comprising:
forwarding the COT scheduling information to a third network device to allocate radio resources to one or more UEs which can share the one or more COTs.

28. A communication device in a communication network, comprising:
a processor; and
a memory communicatively coupled to the processor and adapted to store instructions which, when executed by the processor, cause the communication device to perform the following steps:
sending a channel occupancy time (COT) scheduling information related to one or more COTs for sidelink (SL) transmissions between the first UE and the second UE which are not initiated by the first network device to the first network device to allocate the first UE with first radio resources according to the COT scheduling information within the COT; and
receiving a scheduled resource information from the first network device indicating the first radio resources allocated to the first UE to perform a SL transmission.

29. (canceled)
